(19) United States
(12) Patent Application Publication
(10) Pub. No.: US 2020/0079316 A1
(43) Pub. Date: Mar. 12, 2020

(54) SAFETY RESTRAINT SYSTEM AND METHOD

(71) Applicant: GM Global Technology Operations LLC, Detroit, MI (US)

(72) Inventors: Mathew L. Nassoiy, Milford, MI (US); Jennifer Benson, Lake Orion, MI (US); Travis Koss, Macomb, MI (US)

(21) Appl. No.: 16/128,112

(22) Filed: Sep. 11, 2018

(51) Int. Cl. B60R 22/02; B60R 22/34; B60R 22/18; B60R 22/12

(52) U.S. Cl. CPC B60R 22/02; B60R 22/34; B60R 22/18; B60R 22/12; B60N 2/90; B60R 2022/021; B60R 22/023; B60R 2022/1818; B60R 2022/1806

(57) ABSTRACT

The safety restraint system includes a seatbelt retractor fixedly secured to the motor vehicle, a seatbelt webbing, a D-ring fixedly secured to the motor vehicle, a latchplate slidably engaged with the seatbelt webbing, a buckle for releasably capturing the latchplate, and a magnet attached to a vehicle component. The latchplate has a ferro-magnetic portion. The magnet generates a magnetic field to attract and hold the ferro-magnetic portion of the latchplate against the vehicle component.

### INTRODUCTION

The present disclosure relates to safety restraint systems for motor vehicles that have devices or methods for securing the seatbelt and, more particularly, the seatbelt latchplate when the seatbelt is not in use.

Safety restraint systems for restraining occupants in a motor vehicle, generally, employ seatbelt retractors. The seatbelt retractors have a spool around which a seatbelt webbing is wound. The seatbelt webbing may be unwound from the spool by a vehicle occupant and secured around the vehicle occupant by inserting a latchplate slidably coupled to the seatbelt webbing into a seatbelt buckle. When not in use the seatbelt retractor, through the aid of a spring, retracts the seatbelt webbing into the retractor and onto the spool. Typically, the latchplate hangs on a vertical length of the seatbelt webbing between the D-ring and the anchor plate and is positioned between a vehicle trim panel and a side of a vehicle seat back or alternately against the seatback when the safety restraint system is not in use. The mass associated with the latchplate causes the latchplate contact the trim panel and/or the side of the seat back creating noise and vibration issue for the vehicle occupants. Conventional safety restraint systems and methods employ a loop of seatbelt fabric sewn onto the seatbelt webbing and positioned adjacent the latchplate between the latchplate and the vehicle trim panel to prevent the latchplate from hitting the trim panel.

Thus, while current seatbelt restraint systems achieve their intended purpose, there is a need for a new and improved safety restraint system and method for preventing the latchplate from hitting a component of a vehicle, such as a seat side panel or a B-pillar trim panel. The new and improved system and method should reduce or eliminate noise and vibration issues associated with the latchplate banging against the side of the seatback or the vehicle trim panel while locating the latch plate in an easily accessible location for the vehicle occupant.

### SUMMARY

According to several aspects, a safety restraint system for a motor vehicle is provided. The safety restraint system includes a seatbelt retractor fixedly secured to the motor vehicle, a seatbelt webbing, a D-ring fixedly secured to the motor vehicle, a latchplate slidably engaged with the seatbelt webbing, a buckle for releasably capturing the latchplate, and a first magnet attached to a vehicle component. The seatbelt retractor has a frame rotatably supporting a spool. The seatbelt webbing is at least partially wound around the spool. The D-ring is slidably engaged with the seatbelt webbing to change a seatbelt webbing routing direction. The latchplate has a ferro-magnetic portion. The first magnet generates a magnetic field to attract and hold the ferro-magnetic portion of the latchplate against the vehicle component.

In an additional aspect of the present disclosure, the vehicle component is a vehicle trim member.

In another aspect of the present disclosure, a second magnet is attached to the vehicle trim member.

According to several aspects, a third magnet is attached to the vehicle trim member.

In another aspect of the present disclosure, the vehicle component is a vehicle seat member.

According to several aspects, a second magnet is attached to the vehicle seat member.

In another aspect of the present disclosure, a third magnet is attached to the vehicle seat member.

In another aspect of the present disclosure, a stop member is attached to the seatbelt webbing to prevent the latchplate from sliding past the stop member.

In another aspect of the present disclosure, the stop member is a woven seatbelt material sewn on the seatbelt webbing to prevent the latchplate from sliding past the woven seatbelt material.

In another aspect of the present disclosure, the stop member is a button attached to the seatbelt webbing to prevent the latchplate from sliding past the button.

In yet another aspect of the present disclosure, a method for storing a component of a safety restraint system for a motor vehicle is provided. The method includes fixedly securing a seatbelt retractor to the motor vehicle, providing a seatbelt webbing, fixedly securing a d-ring to the motor vehicle, slidably engaging a latchplate with the seatbelt webbing, releasably capturing the latchplate with a buckle, and attaching a first magnet to a vehicle component. The seatbelt retractor has a frame rotatably supporting a spool. The seatbelt webbing is at least partially wound around the spool. The D-ring slidably engages the seatbelt webbing to change a seatbelt webbing routing direction. The latchplate has a ferro-magnetic portion. The first magnet generates a magnetic field for attracting and holding the ferro-magnetic portion of the latchplate against the vehicle component.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1a is a front perspective view of a vehicle seat and a safety restraint system disposed between the seat and a vehicle structure, according to an exemplary embodiment;

FIG. 1b is a front perspective view of a middle or inboard vehicle seat and a seat belt webbing of a safety restraint system disposed along a seat back, according to an exemplary embodiment; and

FIG. 2 is a front perspective view of a vehicle seat and a safety restraint system disposed between the seat and a vehicle structure, according to another exemplary embodiment.

### DETAILED DESCRIPTION

The following description is merely exemplary in nature and is not intended to limit the present disclosure, application, or uses.

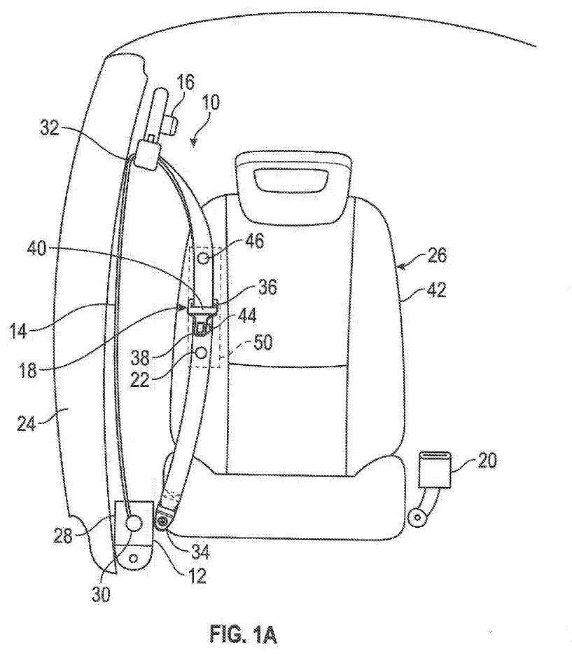

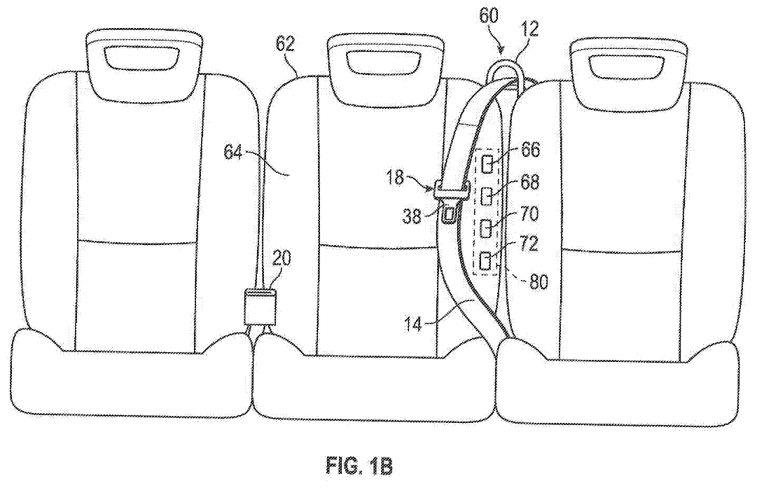

Referring to FIG. 1a, a safety restraint system 10 for a motor vehicle is illustrated, in accordance with an embodiment of the invention. Safety restraint system 10 includes a seatbelt retractor 12, a seatbelt webbing 14, a D-ring 16, a latchplate 18, a buckle 20, and a magnet 22. Seatbelt retractor 12 is fixed to a structural member of the motor vehicle. For example, seatbelt retractor 12 is bolted to the base of the B-pillar 24 or other structural member of the vehicle. Alternatively, the seat belt retractor 12 may be integrated with and fixedly attached to the base of a seat 26 of the motor vehicle. A frame 28 of seatbelt retractor 12 is configured to rotatably support a spool 30 for free rotation in the retractor 12. A spring (not shown) is operatively attached to the frame 28 at one end of the spring and to the spool 30 at another end of the spring to retract the seatbelt webbing 14 onto the spool 30 and into the retractor 12. The seatbelt webbing 14 is at least partially wound around the spool 30 for storing the seatbelt webbing 14 in the retractor 12 when the safety restraint system 10 is not in use. When the safety restraint system 10 is in use the seatbelt webbing 14 is unwound from the spool 30 and pulled out of the retractor 12, typically, by a vehicle occupant. The seatbelt webbing 14 is typically made of a woven fabric material such as woven polyester.

D-ring 16 is fixedly secured to the motor vehicle, generally, towards the top of the B-pillar of the motor vehicle. A slot 32 is provided in D-ring 16 that receives and slidably engages the seatbelt webbing 14. The seatbelt webbing 14 generally extends from the retractor 12 up and along the B-pillar 24 and is threaded or routed through D-ring 16 where the seatbelt webbing 14 is directed down toward the base of the seat 26 and is secured at a terminal end 34 to a structural member of the motor vehicle or to the seat base of the seat 26.

The latchplate 18 has a slot 36 through which the seatbelt webbing is threaded to slidably engage the latchplate 18 with the seatbelt webbing 14. The latchplate 18 is located on the seatbelt webbing 14, generally, between the D-ring 16 and the terminal end 34 of the seatbelt webbing 14. Latchplate 18 has a ferro-magnetic portion 38 and a non-ferro-magnetic portion 40. The buckle 20 is configured to releasably capturing the latchplate 18. Typically, latchplate 18 is pressed into a slot in buckle 20. After the latchplate 18 is fully inserted into the buckle 20 the latchplate 18 is locked in the buckle 20. A button on the buckle 20 is depressed to release the latchplate 18 from buckle 20.

The magnet 22 is attached to a vehicle component such as the B-pillar 24 or the seat 26. The magnet 22 is located vertically in an area between the D-ring 32 and the retractor 12. The magnet 22 generates a magnetic field sufficient to attract and hold the ferro-magnetic portion 38 of the latchplate 18 against the vehicle component, such as B-pillar 24 or seat 26. As shown in FIG. 1a, magnet 22 is attached to seat back 42 of the seat 26. The present disclosure contemplates that additional magnets 44 and 46 may be attached at different locations on the seat back 42 of seat 26. Advantageously, the additional locations for magnets 44, 46 on seat 26 allow the latchplate 18 to be captured and secured at these locations for easy access by the vehicle occupant. Moreover, the present disclosure further contemplates that an elongated magnetic strip 50 may be located on the seat back 42 of seat 26 in place of discrete magnets 22, 44 and 46. Magnets 22, 44 and 46 or magnetic strip 50 may be attached to a structural member of the seat 26, such as a seat frame or to a seat trim panel or sewn into a seat cushion cover material. Permanent magnets, such as, neodymium iron boron (NdFeB), samarium cobalt (SmCo), alnico, and ceramic or ferrite magnets are all suitable magnets for use in the present invention.

With reference now to FIG. 1b, in another aspect of the disclosure a perspective view of a safety restraint system 60 is illustrated disposed in a middle or inboard seat 62 of a motor vehicle. Safety restraint system 60 has the same components as described above with respect to restraint system 10 with like reference numerals depicting like components. In the present embodiment, seatbelt webbing 14 is shown disposed along a vehicle seat back 64. A plurality of magnets 66, 68, 70 and 72 are shown positioned and fixedly secured to the vehicle seat back 64. Magnets 66, 68, 70 and 72 are spaced apart and are, generally, aligned vertically along the seat back. As in the previous embodiment, the ferromagnetic portion 38 of latchplate 18 is attracted by at least one of the plurality of magnets 66, 68, 70 and 72 and held against seat back 64. Advantageously, the additional locations of magnets 66, 68, 70 and 72 on seat back 64 allow the latchplate 18 to be captured and secured at these locations for easy access by the vehicle occupant. Moreover, an elongated magnetic strip 80 may be located on the vehicle seat back 64 in place of discrete magnets 66, 68, 70 and 72. Magnets 66, 68, 70 and 72 or magnetic strip 80 may be attached to a structural member of the seat back 64, such as a seat frame or to a seat trim panel or sewn into a seat back cushion cover material.

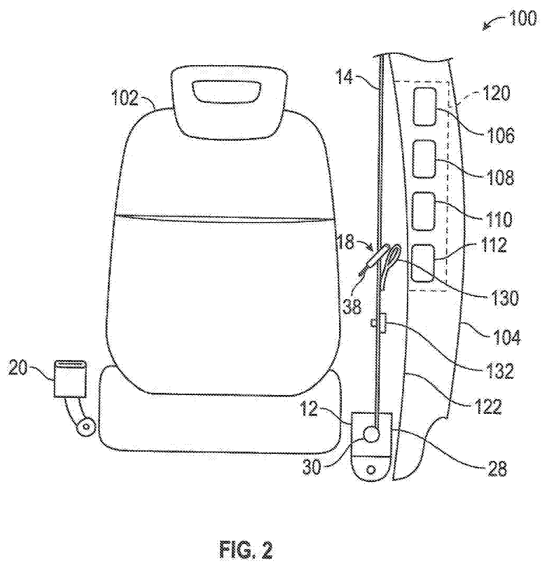

Referring now to FIG. 2, a perspective view of an alternate safety restraint system 100. Safety restraint system 100 has the same components as described above with respect to system 10 with like reference numerals depicting like components. In the present embodiment, seatbelt webbing 14 is shown disposed between a vehicle seat back 102 and a vehicle side support structure 104. Vehicle side support structure 104 is a vehicle B-pillar, C-pillar or D-pillar or similar structure.

With continuing reference to FIG. 2, a plurality of magnets 106, 108, 110 and 112 are shown positioned and fixedly secured to the vehicle side support structure 104. As in the previous embodiment the ferromagnetic portion 38 of latchplate 18 is attracted by at least one of the plurality of magnets 106, 108, 110 and 112. Advantageously, the additional locations for magnets 106, 108, 110 and 112 on vehicle side support structure 104 allow the latchplate 18 to be captured and secured at these locations for easy access by the vehicle occupant. Moreover, an elongated magnetic strip 120 may be located on the vehicle side support structure 104 in place of discrete magnets 106, 108, 110 and 112. Alternatively, magnets 106, 108, 110 and 112 or magnetic strip 120 are secured to a decorative trim panel 122 that overlays and is attached to the vehicle side support structure 104. For example, the magnets 106, 108, 110 and 112 or magnetic strip 120 may be attached to an inside or outside surface of the decorative trim panel 122.

A seatbelt fabric loop 130 is sewn on the seatbelt webbing 14. Loop 130 is sized to prevent the latchplate 18 from sliding further down the webbing 14. In other words, loop 130 is larger than the slot 36 in the latchplate 18 such that the latchplate 18 is not able to slide past the loop 130. However, the size of the loop 130 is much smaller than conventional loops. Conventional loops are much larger as they are designed to function as a buffer between the latchplate 18 and the vehicle side structure 104. Conventional loops need to be sized to substantially cover the latchplate 18 to prevent any part of the latchplate 18 from hitting the vehicle side structure 104 and causing noise and vibration issues. Advantageously, the loop 130 of the present embodiment is much smaller than conventional loops and thus is more aesthetically appealing than conventional loops. Loop 130 only has one function and that is to prevent the latchplate 18 from sliding down the webbing toward the retractor and to a location that would be difficult for a vehicle passenger to access easily. Alternatively, a button 132 or similar device may be attached to webbing 14 at a predetermined position in place of loop 130. Button 132 is larger than the slot 36 in the latchplate 18 such that the latchplate 18 is not able to slide past the button 132.

The features of the safety restraint systems 10, 60, and 100 of the present disclosure offers several advantages. These include the reduction or elimination of noise and vibration issues caused by the latchplate 18 hitting or contacting adjacent vehicle components, such as the vehicle seat 26, seat back 64 or structural supports such as the B, C or D-pillars. Moreover, the aspects of the present disclosure allow the vehicle occupant to locate the latchplate 18 in a convenient location for the occupant. Different occupants may have a preference where the latchplate 18 is located or stored based on the size of the occupant or other factors.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A safety restraint system for a motor vehicle, the safety restraint system comprising:
a seatbelt retractor fixedly secured to the motor vehicle, wherein the seatbelt retractor has a frame rotatably supporting a spool;
a seatbelt webbing at least partially wound around the spool;
a d-ring fixedly secured to the motor vehicle, wherein the d-ring slidably engages the seatbelt webbing to change a seatbelt webbing routing direction;
a latchplate slidably engaged with the seatbelt webbing, wherein the latchplate has a ferro-magnetic portion;
a buckle for releasably capturing the latchplate; and
a first magnet attached to a vehicle component, wherein the first magnet generates a magnetic field for attracting and holding the ferro-magnetic portion of the latchplate against the vehicle component.

2. The safety restraint system of claim 1, wherein the vehicle component is a vehicle trim member.

3. The safety restraint system of claim 2, further comprising a second magnet attached to the vehicle trim member.

4. The safety restraint system of claim 3, further comprising a third magnet attached to the vehicle trim member.

5. The safety restraint system of claim 1, wherein the vehicle component is a vehicle seat member.

6. The safety restraint system of claim 5, further comprising a second magnet attached to the vehicle seat member.

7. The safety restraint system of claim 6, further comprising a third magnet attached to the vehicle seat member.

8. The safety restraint system of claim 1, further comprising a stop member attached to the seatbelt webbing to prevent the latchplate from sliding past the stop member.

9. The safety restraint system of claim 8, wherein the stop member is a woven seatbelt material sewn on the seatbelt webbing to prevent the latchplate from sliding past the woven seatbelt material.

10. The safety restraint system of claim 9, wherein the stop member is a button attached to the seatbelt webbing to prevent the latchplate from sliding past the button.

11. A method for storing a component of a safety restraint system for a motor vehicle, the method comprising:
fixedly securing a seatbelt retractor to the motor vehicle, wherein the seatbelt retractor has a frame rotatably supporting a spool;
providing a seatbelt webbing at least partially wound around the spool;
fixedly securing a d-ring to the motor vehicle, wherein the d-ring slidably engages the seatbelt webbing to change a seatbelt webbing routing direction;
slidably engaging a latchplate with the seatbelt webbing, wherein the latchplate has a ferro-magnetic portion;
releasably capturing the latchplate with a buckle; and
attaching a first magnet to a vehicle component, wherein the first magnet generates a magnetic field for attracting and holding the ferro-magnetic portion of the latchplate against the vehicle component.

12. The method of claim 11, wherein attaching a first magnet to a vehicle component further comprises attaching the first magnet to a vehicle trim member.

13. The method of claim 12, further comprising attaching a second magnet to the vehicle trim member.

14. The method of claim 13, further comprising attaching a third magnet to the vehicle trim member.

15. The method of claim 11, wherein attaching a first magnet to a vehicle component further comprises attaching the vehicle component to a vehicle seat member.

16. The method of claim 15, further comprising attaching a second magnet to the vehicle seat member.

17. The method of claim 16, further comprising attaching a third magnet to the vehicle seat member.

18. The method of claim 11, further comprising attaching a stop member to the seatbelt webbing to prevent the latchplate from sliding past the stop member.

19. The method of claim 18, wherein attaching a stop member to the seatbelt webbing further comprises sewing a woven seatbelt material on the seatbelt webbing to prevent the latchplate from sliding past the woven seatbelt material.

20. The method of claim 19, wherein attaching a stop member to the seatbelt webbing further comprises attaching a button to the seatbelt webbing to prevent the latchplate from sliding past the button.
